(19) United States
(12) Patent Application Publication
(10) Pub. No.: US 2009/0135379 A1
(43) Pub. Date: May 28, 2009

(54) ADJUSTING APPARATUS FOR PROJECTOR

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY(ShenZhen) CO., LTD., Shenzhen City (CN); HON HAI PRECISION INDUSTRY CO., LTD., Tu-Cheng (TW)

(21) Appl. No.: 11/960,747

(22) Filed: Dec. 20, 2007

(30) Foreign Application Priority Data
Nov. 23, 2007 (CN) 200710202646.8

(51) Int. Cl. G03B 21/14; G03B 21/22

(52) U.S. Cl. 353/119

(57) ABSTRACT

An adjusting apparatus is provided for a projector having a front wall defining a slot therein, and a bottom wall defining a D-shaped through hole therein. The adjusting apparatus includes an operating member rotatably supported in the projector and partially exposed out of the projector from the slot of the front wall, and a supporting member having a D-shaped cross section. The operating member defines a threaded hole therein. The supporting member extends through the D-shaped through hole of the bottom wall of the projector and is partially received in the projector. The supporting member forms a plurality of threads thereon for mating with the threaded hole of the operating member. When the operating member is rotated in either of two directions, the projector correspondingly moves up or down relative to the supporting member.

### BACKGROUND

1. Field of the Invention

The present invention relates to adjusting apparatuses for projectors, and more particularly to an adjusting apparatus for adjusting elevation and depression angles of a projector.

2. Description of Related Art

With the development of electronic technology, projectors have come into wide use in multimedia presentations. Typically, a projector includes an adjusting apparatus installed at a front section or a rear section of the bottom of the projector, for adjusting elevation and depression angles of the projector to meet the needs of a user. The adjusting apparatus includes a foot movably supporting a shell of the projector, and a button. Pressing the button, the foot is moved up or down relative to the shell of the projector. When the projector is adjusted to a proper elevation or depression angle, the button is released and locks the foot to the shell. However, when the button is pressed by one hand of a user, the user needs to support the shell with the other hand and raise or descend the shell relative to the foot. It is difficult and inconvenient.

What is needed, therefore, is an adjusting apparatus which facilitates convenient adjustment of elevation and depression angles of a projector.

### SUMMARY

An exemplary adjusting apparatus is provided for a projector having a front wall defining a slot therein, and a bottom wall defining a D-shaped through hole therein. The adjusting apparatus includes an operating member rotatably supported in the projector and partially exposed out of the projector from the slot of the front wall, and a supporting member having a D-shaped cross section. The operating member defines a threaded hole therein. The supporting member extends through the D-shaped through hole of the bottom wall of the projector and is partially received in the projector. The supporting member forms a plurality of threads thereon for mating with the threaded hole of the operating member. When the operating member is rotated in either of two directions, the projector correspondingly moves up or down relative to the supporting member.

Other advantages and novel features will become more apparent from the following detailed description of embodiments when taken in conjunction with the accompanying drawings, in which:

### BRIEF DESCRIPTION OF THE DRAWINGS

FIG. 1 is an exploded, isometric assembled view of an adjusting apparatus with a projector in accordance with an embodiment of the present invention;

FIG. 2 is a partially enlarged view of FIG. 1;

FIG. 3 is similar to FIG. 1, but viewed from another aspect;

FIG. 4 is an assembled view of FIG. 1; and

FIG. 5 is a partial cross-sectional view taken along line V-V of FIG. 4.

### DETAILED DESCRIPTION

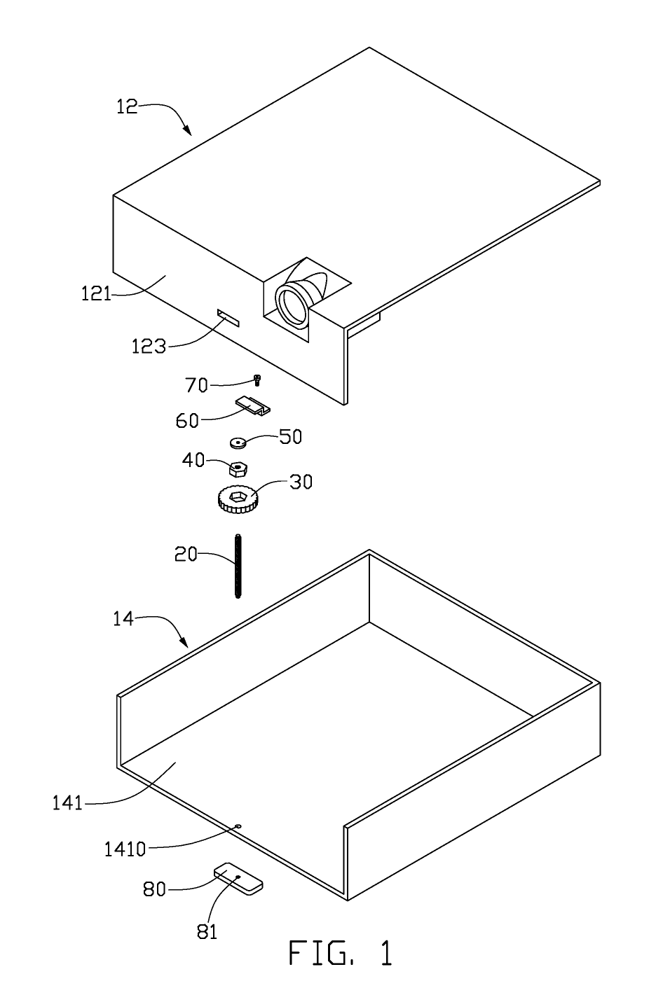

Referring to FIGS. 1 to 4, an adjusting apparatus is provided in accordance with an embodiment of the present invention for adjusting elevation and depression angles of a projector 10. The adjusting apparatus includes a supporting member 20, a discoid operating member 30, a stop plate 50 defining a threaded hole 51 therein, and a fixing member 60.

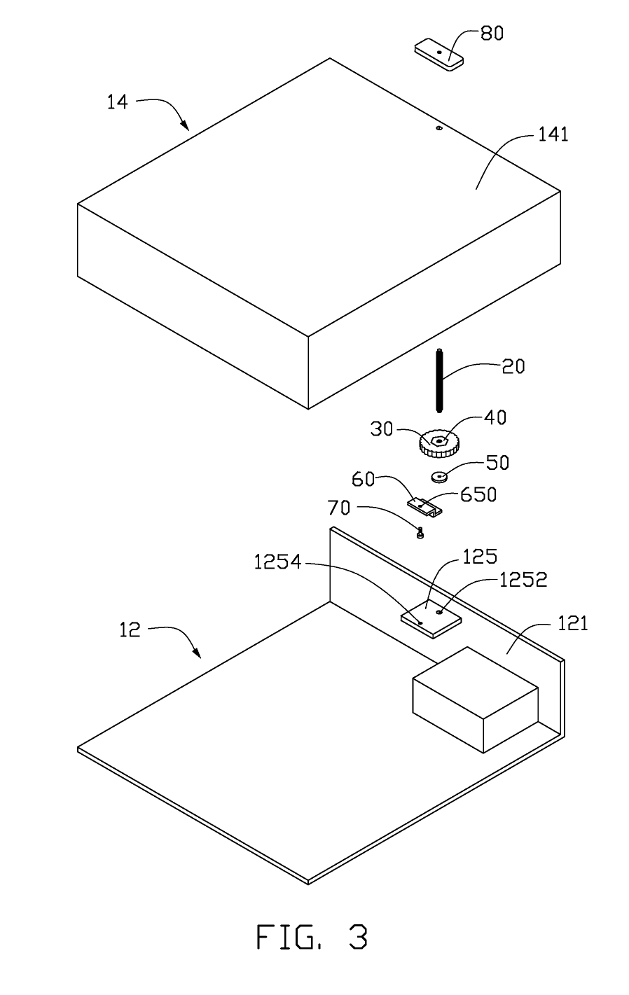

The projector 10 includes a base 14, and a cover 12. The cover 12 includes a front wall 121 defining a slot 123 in a middle portion thereof. A supporting plate 125 (see FIG. 3) is formed on an inside surface of the front wall 121 adjoining the bottom section of the slot 123. The supporting plate 125 defines a D-shaped through hole 1252, and a threaded hole 1254 therein. The base 14 includes a bottom wall 141, and a D-shaped through hole 1410 is defined in a middle portion of a front section of the bottom wall 141.

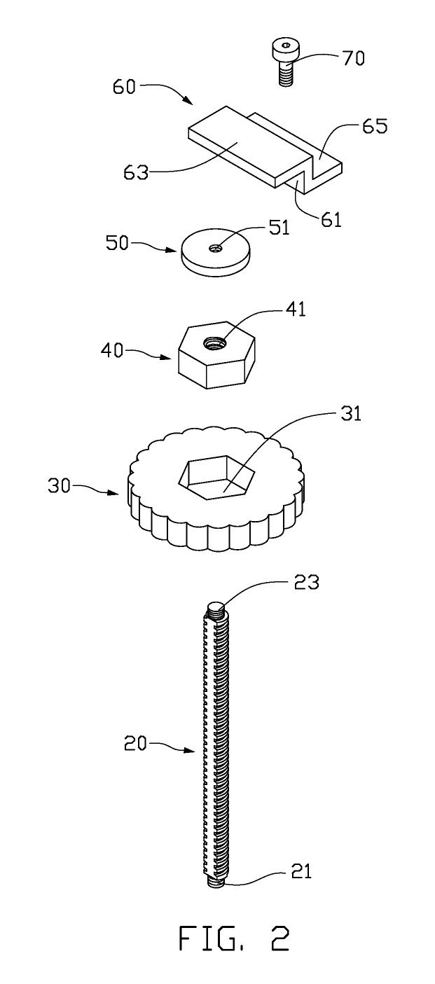

Referring particular to FIG. 2, the supporting member 20 includes a main body having D-shaped cross section, and two slender threaded portions 21, 23 extending from opposite ends of the main body respectively. The main body includes a threaded arcuate surface and a planar surface adjoining the arcuate surface.

The operating member 30 defines a polygonal hole 31 in a middle portion thereof, and a plurality of teeth is formed on the circumference of the operating member 30. A rotating member 40 is provided to be received in the polygonal hole 31 of the operating member 30. In this embodiment, the rotating member 40 is a nut defining a threaded hole 41 therein.

The fixing member 60 includes a vertical plate 61, a first plate 63 perpendicularly extending from an upper longitudinal edge of the vertical plate 61 in a first direction, and a second plate 65 perpendicularly extending from a lower longitudinal edge of the vertical plate 61 in a second direction opposite to the first direction. A fixing hole 650 (see FIG. 3) is defined in the second plate 65.

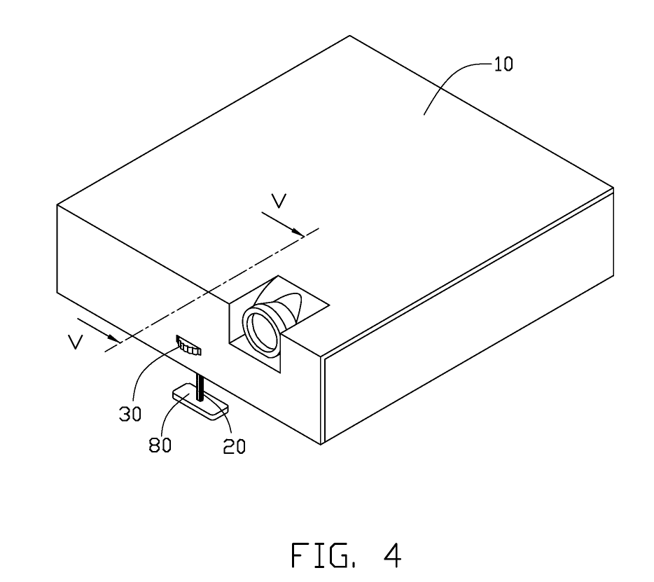

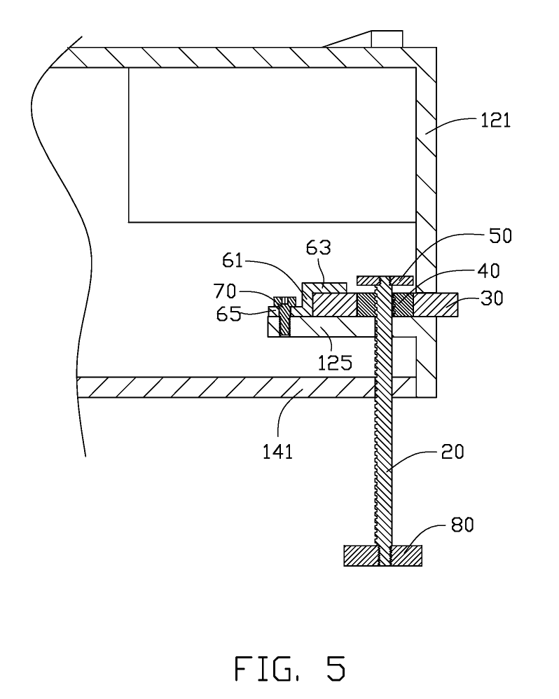

Referring further to FIGS. 4 and 5, in assembly, the rotating member 40 engages in the polygonal hole 31 of the operating member 30, and the operating member 30 together with the rotating member 40 are placed on the supporting plate 125 of the projector 10, with part of the operating member 30 being exposed out of the front wall 121 from the slot 123 thereof, and the threaded hole 41 of the rotating member 40 aligning with the through hole 1252 of the supporting plate 125. The fixing member 60 is placed on the supporting plate 125, with the first plate 63 abutting against a top surface of the operating member 30, the second plate 65 contacting with the supporting plate 125, and the fixing hole 650 of the second plate 65 aligning with the threaded hole 1254 of the supporting plate 125. A fastener 70, such as a screw, is extended through the fixing hole 650 and then engages in the threaded hole 1254. Thereby, the fixing member 60 is fixed to the supporting plate 125, and presses the operating member 30 to the supporting plate 125. One end of the supporting member 20 adjacent to the threaded portion 23 is extended through the D-shaped through hole 1252 of the supporting plate 125 and then partially engages in the threaded hole 41 of the rotating member 40. The supporting member 21 slidably engages with the through hole 1252 and is unable to rotate relative to the through hole 1252. The operating member 30 is driven to rotate. The rotating member 40 is rotated with the operating member 30 to make the threaded hole 41 entirely engage with the threads of the main body of the supporting member 20, thereby driving the cover 12 to move downward relative to the supporting member 20. The threaded portion 23 is exposed out of the threaded hole 41 of the rotating member 40. Thereafter, the stop plate 50 is rotated to allow the threaded portion 23 to engage in the threaded hole 51 of the stop plate 50. Thereby, the stop plate 50 is attached to a top portion of the supporting member 20, for preventing the supporting member 20 from disengaging from the threaded hole 41 of the rotating member 40. The opposite end of the supporting member 20 adjacent to the threaded portion 21 is extended through the D-shaped through hole 1410 of the bottom wall 141 of the base 14. Then, the cover 12 is fixed to the base 14, and a foot 80 having a threaded hole 81 therein is connected to the threaded portion 21 of the supporting member 20, with the threaded portion 21 engaging in the threaded hole 81 of the foot 80.

The projector 10 is placed on a plane, with the foot 80 and a rear portion of the bottom wall 141 contacting the plane. When there is a need to adjust the elevation or depression angle of a projector 10, the operating member 30 is rotated to make the rotating member 40 to rotate together with the operating member 30 to drive the projector 10 to correspondingly move up or down relative to the supporting member 20. Thereby, the elevation or depression angle of the projector 10 is changed.

In this embodiment, when the rotating member 40 is broken, the rotating member 40 can be replaced without needing to replace the operating member 30.

In another embodiment, the rotating member 40 is omitted, and the polygonal hole 31 of the operating member 30 may be replaced by a threaded hole, for engaging with the main body of the supporting member 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An adjusting apparatus for a projector having a front wall and a bottom wall, the front wall defines a slot therein, and the bottom wall defining a D-shaped through hole therein, the adjusting apparatus comprising:
an operating member rotatably supported in the projector and partially exposed out of the projector from the slot of the front wall, the operating member defining a threaded hole therein; and
a supporting member having a D-shaped cross section, the supporting member extending through the D-shaped through hole of the bottom wall of the projector and partially received in the projector, the supporting member forming a plurality of threads thereon for mating with the threaded hole of the operating member, the operating member rotated to drive the supporting member for moving up or down the projector relative to the supporting member.

2. The adjusting apparatus as claimed in claim 1, wherein the operating member defines a polygonal hole therein, a rotating member engages in the polygonal hole of the operating member, and the threaded hole is defined in the rotating member.

3. The adjusting apparatus as claimed in claim 1, wherein a supporting plate is formed on an inside surface of the front wall of the projector for supporting the operating member.

4. The adjusting apparatus as claimed in claim 3, wherein the supporting plate defines a D-shaped through hole therein, the supporting member extends through the D-shaped through hole of the supporting plate and then engages in the threaded hole of the operating member.

5. The adjusting apparatus as claimed in claim 3, further comprising a fixing member mounted on the supporting plate, the fixing member comprising a first plate abutting against a top surface of the operating member for pressing the operating member to the supporting plate.

6. The adjusting apparatus as claimed in claim 1, wherein a stop plate is connected to one end of the supporting member received in the projector, for preventing the supporting member from disengaging from the operating member.

7. The adjusting apparatus as claimed in claim 6, wherein a foot is connected to the opposite end of the supporting member out the projector, for supporting the projector.

8. A projector having an adjusting apparatus, the projector comprising:
a bottom wall defining a D-shaped through hole therein;
an operating member rotatably supported in the projector and manipulated from outside of the projector, the operating member defining a threaded hole therein and bi-directionally rotatable around a first axis; and
a supporting member having a D-shaped cross section, the supporting member extended into the projector from the D-shaped through hole of the bottom wall, the supporting member forming a plurality of threads thereon to mate with the threaded hole of the operating member, the supporting member correspondingly linearly moving up and down along a second axis perpendicular to the first axis when the rotating member is rotated.
